(19) United States
(12) Patent Application Publication
(10) Pub. No.: US 2019/0303834 A1
(43) Pub. Date: Oct. 3, 2019

(54) METHOD AND DEVICE FOR TRACING ISSUES IN AN END-TO-END PROCESS USING DISTRIBUTED LEDGER

(71) Applicant: Wipro Limited, Bangalore (IN)

(72) Inventors: Sanjoy Paul, Sugar Land, TX (US); Senthil Kumaresan, Bangalore (IN)

(21) Appl. No.: 15/937,319

(22) Filed: Mar. 27, 2018

(51) Int. Cl. G06Q 10/06; G06N 99/00

(52) U.S. Cl. CPC G06Q 10/06395; G06Q 30/0185; G06N 99/005

(57) ABSTRACT

A method and device for tracing issues in an end-to-end process is disclosed. The method includes identifying a plurality of stakeholders involved in the end-to-end process and a plurality of vectors associated with each of the plurality of stakeholders, determining a plurality of parameters associated with each of the plurality of vectors for each of the plurality of stakeholder, comparing values associated with each of the plurality of parameters with corresponding threshold values for each of the plurality of stakeholders, collating deviation information associated with at least one of the plurality of parameters based on the comparing on a distributed ledger network, evaluating a resultant product or service obtained after the end-to-end process based on predefined quality standards, and upon evaluating, tracing an issue and a location of the issue in the end-to end process using the deviation information collated on the distributed ledger network.

### FIELD

This disclosure relates generally to tracing issues in an end-to-end process, and more particularly to method and device for tracing issues in an end-to-end process using distributed ledger.

### BACKGROUND

An end-to-end process generally relates to a chain of steps that must be performed for accomplishing a task. An example of an end-to-end process is delivery of a product or service. Such an end-to-end process of delivering a product may involve multiple steps and multiple stakeholders. As such, any issue occurring at any of the intermediate steps may adversely affect the final product or service to be delivered. For example, as a result of being affected by an issue, the final product or service may suffer a drop in quality, which may further lead loss of market share, and recalling of the product or re-performing of the service. As a result, the overall cost of the end-to-end process may increase. A few examples of some end-to-end processes marred by issues like frauds include the horse meat scandal and fake bomb detectors.

In conventional techniques executing end-to-end processes, only limited information is available about present product delivery scenario. Further, the information may not be available to all the stakeholders in the process, and a stakeholder may be able to access information of only one immediate next step in the end-to-end processes. Furthermore, the information is controlled by one central ledger. Therefore, the stakeholders responsible for the occurrence of the issue in the end-to-end processes may go unnoticed. As a result, there is a greater chance of resultant products or services from the end-to-end processes to be affected by issues, which may lead to defected resultant products or services.

### SUMMARY

In one embodiment, a method for tracing issues in an end-to-end process is described. The method includes identifying a plurality of stakeholders involved in the end-to-end process and a plurality of vectors associated with each of the plurality of stakeholders. The method further includes determining for each of the plurality of stakeholder, a plurality of parameters associated with each of the plurality of vectors; comparing for each of the plurality of stakeholders, values associated with each of the plurality of parameters with corresponding threshold values. The method includes collating deviation information associated with at least one of the plurality of parameters based on the comparing on a distributed ledger network. The method further includes evaluating a resultant product or service obtained after the end-to-end process based on predefined quality standards. The method includes tracing an issue and a location of the issue in the end-to end process using the deviation information collated on the distributed ledger network, such that tracing of the issue and the location is initiated based on the evaluating.

In another embodiment, an issue tracing device for tracing issues in an end-to-end process is described. The issue tracing device includes a processor and a memory communicatively coupled to the processor, wherein the memory stores processor instructions, which, on execution, causes the processor to identify a plurality of stakeholders involved in the end-to-end process and a plurality of vectors associated with each of the plurality of stakeholders. The processor instructions further cause the processor to determine for each of the plurality of stakeholder, a plurality of parameters associated with each of the plurality of vectors. The processor instructions cause the processor to determine values associated with each of the plurality of parameters associated with each of the plurality of vectors. The processor instructions further cause the processor to compare for each of the plurality of stakeholders, values associated with each of the plurality of parameters with corresponding threshold values. The processor instructions further cause the processor to collate deviation information associated with at least one of the plurality of parameters based on the comparing on a distributed ledger network. The processor instructions cause the processor to evaluate a resultant product or service obtained after the end-to-end process based on predefined quality standards. The processor instructions further cause the processor to trace an issue and a location of the issue in the end-to end process using the deviation information collated on the distributed ledger network, such that tracing of the issue and the location is initiated based on the evaluating.

In yet another embodiment, a non-transitory computer-readable storage medium is disclosed. The non-transitory computer-readable storage medium has instructions stored thereon, a set of computer-executable instructions causing a computer comprising one or more processors to perform steps comprising identifying a plurality of stakeholders involved in the end-to-end process and a plurality of vectors associated with each of the plurality of stakeholders; determining for each of the plurality of stakeholder, a plurality of parameters associated with each of the plurality of vectors, determining values associated with each of the plurality of parameters associated with each of the plurality of vectors; comparing for each of the plurality of stakeholders, values associated with each of the plurality of parameters with corresponding threshold values; collating deviation information associated with at least one of the plurality of parameters based on the comparing on a distributed ledger network; evaluating a resultant product or service obtained after the end-to-end process based on predefined quality standards; and tracing an issue and a location of the issue in the end-to end process using the deviation information collated on the distributed ledger network, wherein tracing of the issue and the location is initiated based on the evaluating.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for tracing issues in an end-to-end process using distributed ledger, in accordance with an embodiment.

FIG. 2 illustrates a block diagram of a memory of an issue tracing device configured to trace issues in an end-to-end process using distributed ledger, in accordance with an embodiment.

FIG. 3 illustrates a flowchart of a method for tracing issues in an end-to-end process using distributed ledger, in accordance with an embodiment.

FIG. 4 illustrates a flowchart of a method for tracing issues in an end-to-end process using distributed ledger, in accordance with another embodiment.

FIG. 5 illustrates a flowchart of a method for evaluating a resultant product or service obtained after an end-to-end process based on predefined quality standards, in accordance with an embodiment.

FIG. 6 illustrates a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

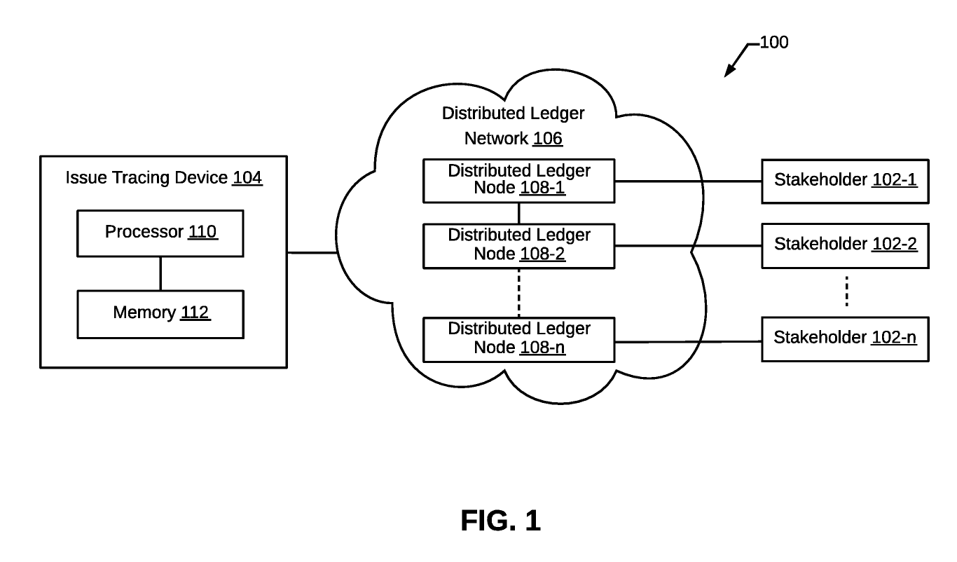

In one embodiment, a system 100 for tracing issues in an end-to-end process using distributed ledger is illustrated in FIG. 1. The system 100 may allow for tracing one or more issues that may have an impact on the end-to-end process. The end-to-end process may relate to a chain or sequence of steps that are required to be performed in order to accomplish a task or deliver a result. By way of an example, an end-to-end process may be a supply chain process for delivering a finished product, such as, an agricultural product.

The system 100 may employ the techniques of Internet of Things (IoT) and distributed ledger, for example, Blockchain, and therefore may allow for identifying irregularities and locating the exact issue in one of the steps in the end-to-end process, which may ultimately lead to production/delivery of a sub-standard or faulty product/service. Examples of issues may include, but are not limited to intermediate inputs in the end-to-end process, which do not meet industry established quality standards or specification. The intermediate inputs may be in the form of product or services.

In the system 100, stakeholders 102-1 to 102-n, collectively referred to as a plurality of stakeholders 102, provide inputs for execution and completion of the end-to-end process. The issues may be introduced in the end-to-end process as a result of one of these inputs provided by the plurality of stakeholders 102. The plurality of stakeholders 102 may team up to deliver a product or service through the end-to-end process. Each of the plurality of stakeholders 102 may be responsible for carrying out a required task at each step of the end-to-end process. By way of an example, in an end-to-end process pertaining to agricultural process, the plurality of stakeholders 102 may include farmers, aggregators, manufacturers, and retailers. It may be understood that the farmers may be responsible for providing raw materials, such as fruits and vegetables. The aggregators may source the raw materials and may further clean the sourced raw materials. The manufacturers, on other hand, may process the raw materials to make a finished food product. The retailers may procure finished food products, and sell the finished food product to the consumers through points of sale, such as, stores and e-commerce portals. Thus, the issues may be introduced by one or more of farmers, aggregators, manufacturers, and retailers.

In order to trace the issues occurring in the end-to-end process, the system 100 may include an issue tracing device 104 and a distributed ledger network 106. The issue tracing device 104, for example, may be one of, but is not limited to an application server, a laptop, a desktop, a smartphone, or a tab. The issue tracing device 104 may also be implemented in form of a distributed system. The distributed ledger network 106 may be a Blockchain network or a Hashgraph network. The issue tracing device 104 may be communicatively coupled to the distributed ledger network 106 via a network (not shown in FIG. 1), and may thus be able to access information stored in the distributed ledger network 106. The network may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

The distributed ledger network 106 further includes distributed ledger nodes 108-1, 108-2 to 108-n, collectively referred to as plurality of distributed ledger nodes 108. Each of the plurality of distributed ledger nodes 108 may be in communication with one of the plurality of stakeholder 102. As shown in FIG. 1, the distributed ledger node 108-1 is communicatively coupled to the stakeholder 102-1, the distributed ledger node 108-2 is communicatively coupled to the stakeholder 102-2, and the distributed ledger node 108-n is communicatively coupled to the stakeholder 102-n. Each of the plurality of stakeholders 102 may have various IoT sensors installed at their respective areas of operations in order to monitor various parameters. Thus, IoT sensors of stakeholders may communicate with an associated distributed ledger node in order to store information on the associated distributed ledger node. By way of an example, IoT sensors associated with the stakeholder 102-1 may store information captured for the stakeholder 102-1 on the distributed ledger 108-1. Alternatively, various entities associated with each of the plurality of stakeholders 102 may store information on an associated one of the plurality of distributed ledger nodes 108. The entities may include people employed by a stakeholder. In other words, the information may be manually stored on the distributed ledger network 106.

The distributed ledger network 106 includes a continuously growing list of interlinked records called a distributed ledger exchanged between the plurality of distributed ledger nodes 108. The records in the distributed ledger may be secured through cryptography, such that the records cannot be modified or tampered with. The distributed ledger may record transactions between two parties in a verifiable and permanent way. Accordingly, the distributed ledger network 106 may permanently record each communication received from the plurality of stakeholders 102. This information may later be accessed by the issue tracing device 104. When the distributed ledger network 106 is a Blockchain network, data storage may use a single Blockchain platform or multiple Blockchain platforms. In this case, a Blockchain Bridge may handle these multiple Blockchain platforms.

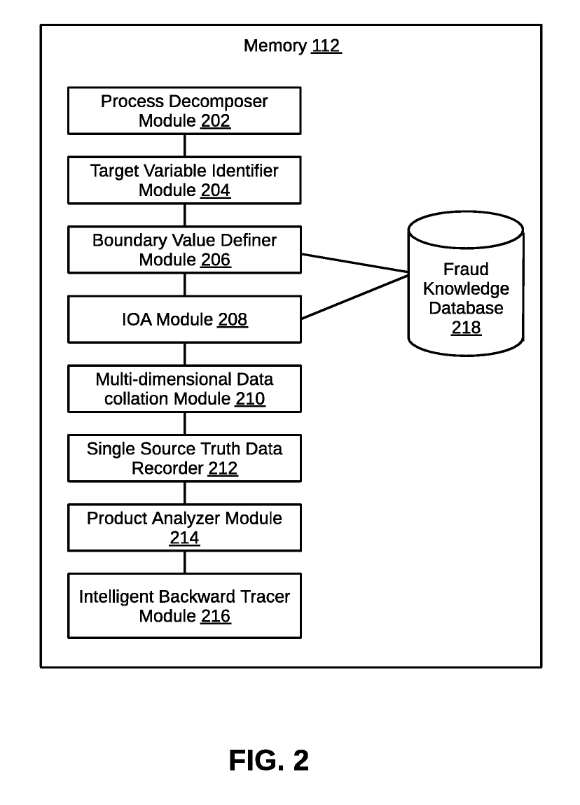

The issue tracing device 104 may further include a processor 110 that may be communicatively coupled to a memory 112. The memory 112 stores processor instructions, which on execution cause the processor 110 to trace any issues in the end-to-end process. The memory 112 may be a non-volatile memory or a volatile memory. Examples of the non-volatile memory, may include, but are not limited to a flash memory, a Read Only Memory (ROM), a Programmable ROM (PROM), Erasable PROM (EPROM), and Electrically EPROM (EEPROM) memory. Examples of the volatile memory may include, but are not limited Dynamic Random Access Memory (DRAM), and Static Random-Access memory (SRAM). The memory 112 may further include various modules, which are explained in detail in conjunction with FIG. 2.

Referring now to FIG. 2, the memory 112 of the issue tracing device 104 configured to trace issues in an end-to-end process using distributed ledger is illustrated, in accordance with an embodiment. The memory 112 includes a process decomposer module 202, a target variable identifier module 204, a boundary value definer module 206, an Input Output Action (IOA) module 208, a multi-dimensional data collation module 210, a single source of truth data recorder 212, a product analyzer module 214, and an intelligent backward tracer module 216.

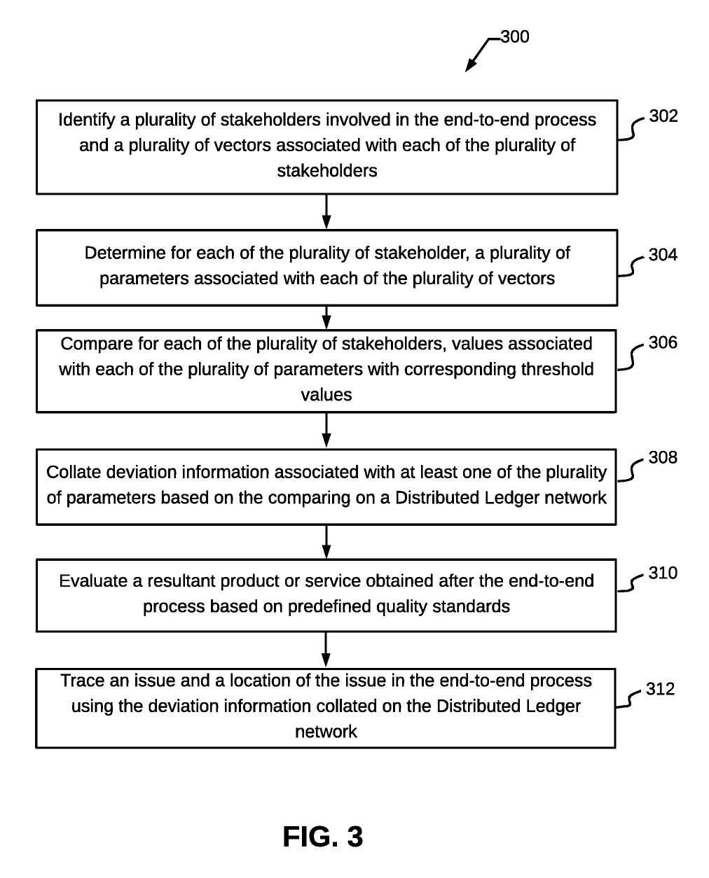

The process decomposer module 202 may identify the various steps involved in the end-to-end process. The steps of the end-to-end process may be identified manually. Alternatively, the steps of the end-to-process may be identified by automation using machine learning techniques. The process decomposer module 202 may further identify the plurality of stakeholders 102 involved in various steps of the end-to-end process. Furthermore, the process decomposer module 202 may identify a plurality of vectors associated with the plurality of stakeholders 102. The plurality of vectors may be factors that affect the resulting product or service obtained from the end-to-end process. The plurality of vectors may include different types of vectors, such as, input vectors, output vectors, and action vectors, associated with each of the plurality of stakeholders 102. This is further explained in detail in conjunction with FIG. 3

Once the plurality of stakeholders 102 and the plurality of vectors are identified, the target variable identifier module 204 may identify parameters associated with each of the plurality of vectors, for each of the plurality of stakeholder 102. By way of an example, the target variable identifier module 204 may employ regression and classification techniques for identifying the parameters associated with each of the plurality of vectors. The input, output, and action vectors are refined at the end of this process. Depending upon the product, region, number and profile of the plurality of stakeholder 102, rules for identifying parameters may be altered automatically.

The boundary value definer module 206 may determine values for each of the plurality of parameters associated with each of the plurality of vectors. For each of the input, output, and action vectors, the boundary value definer module 206 may determine source of input. In other words, it may be determined whether an input vector for a stakeholder is an output vector of a preceding stakeholder, and vice versa. Additionally, boundary value definer module 206 defines the normal and abnormal range of values for each of the plurality of parameters. It may be noted that values of the parameters associated with input vectors and output vectors may be determined by human intervention, and may further be certified by human intervention. However, values of the parameters associated with the action vectors may be measured using one or more IoT sensors. The rules for each of the plurality of vectors (i.e., input, action, and output vectors) may be stored in a fraud knowledge database 218. These rules are further explained in detail at step 306 in FIG. 3.

The IOA module 208 may analyze data as it is streamed continuously in real time from the input vectors, output vectors, and action vectors. In other words, the IOA module 208 may compare values associated with each of the plurality of parameters for the plurality of vectors with corresponding threshold values, for each of the plurality of stakeholders 102. The threshold values pertaining to each of the plurality of vectors may be stored in and retrieved from the fraud knowledge database 218. Based on the comparison, deviation information of the values associated with the parameters of plurality of vectors, with respect to the threshold values is determined. This is further explained in detail in conjunction with FIG. 3.

The multi-dimensional data collation module 210 may collate the deviation information associated with one or more of the plurality of parameters associated with the plurality of vectors. The multi-dimensional data collation framework 210 may include built-in adapters that may curate the deviation information from the various sources based on a mashup script. This is further explained in detail in conjunction with FIG. 3.

The single source of truth data recorder 212 may then record the deviation information on the distributed ledger network 106. Based on past learning, the single source of truth data recorder 212 collates data from multiple other external sources to provide a single unified view. The single source of truth data recorder 212 may further share the recorded information with the distributed ledger network 106. The product analyzer module 214 may evaluate the resultant product or service obtained after the end-to-end process based on predefined quality standards. The product analyzer module 214 may perform the evaluation by using automation software based on image recognition. Alternatively, the evaluation may be performed manually. This is further explained in detail in conjunction with FIG. 3.

Once the evaluation of the finalized product or service is performed by the product analyzer module 214, the intelligent backward tracer module 216 may trace an issue and a location of the issue that may have occurred in the end-to end process. The intelligent backward tracer module 216 may use the deviation information collated on the distributed ledger network 106. Based on the deviation information, the intelligent backward tracer module 216 may go backward and inspect the information that is recorded in the distributed ledger network 106 to identify the deviations and the exact location where deviations may have occurred. Accordingly, the issue and the location of the issue is identified. Further, based on the issue and a location of the issue, a corresponding stakeholder who took a fraudulent or inappropriate action that may have led to the issue, may be identified. This is further explained in detail in conjunction with FIG. 3.

Referring now to FIG. 3, a flowchart of a method 300 for tracing issues in an end-to-end process using distributed ledger is illustrated, in accordance with an embodiment. At step 302, issue tracing device 104 identifies the plurality of stakeholders 102 involved in the end-to-end process. The end-to-end process may include a chain of steps that must be performed in order to accomplish a task. The plurality of stakeholders 102 may be the entities responsible for performing a respective step in the end-to-end process. By way of an example, an end-to-end process may be for delivering a finished product, such as an agricultural product, and the plurality of stakeholders 102 may include farmers, aggregators, manufacturers, and retailers. Thus, in this case, the issue tracing device 104 may identify the above mentioned list of stakeholders. It may be understood that steps to be performed and the stakeholders may vary from one end-to-end process to another, depending upon the type of the finalized product or service being delivered by the end-to-end process. The end-to-end process and the plurality of stakeholder involved has already been explained in detail in conjunction with FIG. 1.

Further, at step 302, issue tracing device 104 may also identify a plurality of vectors associated with each of the plurality of stakeholders 102. The plurality of vectors may be factors which may have an effect on the finalized product or service. The plurality of vectors may include input vectors, output vectors, and action vectors. Each given stakeholder may have an associated set of input vectors, output vectors, and action vectors, such that, the action vectors act upon the input vectors to generate the output vectors. By way of an example, in an end-to-end process for delivering an agricultural product, for the farmer (stakeholder), the input vectors may be related to one or more of seeds, season, and pesticide. Similarly, the action vectors for the farmer may be related to one or more of sowing, soil, sunlight, and irrigation. When these action vectors act upon the input vectors, the following output vectors, which may be related to one or more of leaf, flower, and fruit, are generated for the farmer. In an embodiment, the plurality of input vectors and output vectors may be identified manually, and may require human certification. However, the action vectors, on the other hand, may be measured using different types of sensors, for example, IoT sensors.

It will be apparent to a person skilled in the art that output vectors for a given stakeholder may be input vectors for other stakeholder in the plurality of stakeholders 102.

The plurality of stakeholders 102 and the plurality of vectors associated with each of the plurality of stakeholders 102 may be identified using various machine learning techniques. The machine learning techniques may include, but are not limited to simple rules, and machine learning models, for example, unsupervised learning and semi-supervised learning. By way of an example, the identification of the stakeholders and sub-product/service segmentation may be done by using unsupervised learning and the text classification may be done using semi-supervised learning. Text classification may be used, for example, to extract relevant information regarding stakeholders out of standard or business agreement made between multiple stakeholders. When multiple stakeholders start to get involved in a business, a standard agreement or a business agreement is executed between all the stakeholders. Such an agreement includes details regarding responsibilities of each stakeholder and final deliverable or output expected from each stakeholder based on an input.

At step 304, the issue tracing device 104 determines a plurality of parameters associated with each of the plurality of vectors for each of the plurality of stakeholders 102. The plurality of parameters may be identified using a mix of supervised learning, such as, regression and classification. In continuation of the example above, for the end-to-end process to deliver an agricultural product, parameters associated with the input vectors may include one or more of seed size, seed origin, seed age, pesticide type, or pesticide make. Similarly, parameters associated with the output vectors may include sowing time, soil humidity, soil composition, soil temperature, frequency of irrigation, quality of sunlight. The parameters associated with the output vectors may include leaf color, leaf texture, flower color, flower smell, flower size, fruit taste, fruit color, and fruit size.

At step 306, issue tracing device 104 compares values associated with each of the plurality of parameters with corresponding threshold values for each of the plurality of stakeholders. The plurality of parameters may be monitored through a continuous sliding window rule engine. In an embodiment, the threshold values for a parameter may define a range within which value associated with the parameter should fall. In another embodiment, the threshold value for a parameter may be a single value. In other words, the threshold values may define boundary values for each of the plurality of vectors. By way of an example, the threshold values for parameters in the input vectors, action vectors, and output vectors may be represented as equations 1, 2, and 3 respectively:

Input Vector: [u1<=I1<=u2, u3<=I2<=u4, . . . , u5<=In<=u6] (1)

Action Vector: [v1<=A1<=v2, v3<=A2<=v4, . . . , v5<=Ak<=v6] (2)

Output Vector: [w1<=O1<=w2, w3<=O2<=w4, w5<=Om<=w6] (3)

### Where,

I1 to In are parameters associated with the input vector;

u represents threshold values for parameters associated with input vectors;

A1 to An are parameters associated with the action vector;

v represents threshold values for parameters associated with action vectors;

O1 to On are parameters associated with the output vector; and

w represents threshold values for parameters associated with output vectors.

In the equation 1, for example, threshold values for the parameter I1 is represented by a range: u1<=I1<=u2. In other words, value for the parameter I1 should not be less than u1 and not be greater than u2. By way of an example, for an end-to-end process of delivering a finished agricultural product, the input vector for a famer (stakeholder), which includes the associated parameters along with associated threshold values may be represented by equation 4 given below:

Input Vector: [0.01 mm<=Seed Size<=0.1 mm; Seed Origin=Kenya or Java; 1 day<=Seed Age<=1 month; Fertilizer Type=Urea; Fertilizer Constituents=Nitrate, Phosphate; Pesticide Type=Organic; Pesticide Constituents=Bacteria X] (4)

In equation 4 above, seed size, seed origin, seed age, fertilizer type, fertilizer constituent, pesticide type, and pesticide constituents are all parameters associated with the input vector for the farmer. The threshold values are also given for each parameters. By way of an example, the threshold value for “Seed Size” is a range from 0.01 mm to 0.1 mm. By way of another example, threshold value for “Seed Origin” is either Kenya or Java. In other words, the seed origin should either be from Kenya or Java.

Based on the comparison at step 306, the deviation information associated with one or more of the plurality of parameters is collated on the distributed ledger network 106. During the comparison at step 306, it may be determined that values of one or more of the plurality of parameters deviate from associated threshold values. Deviation may include scenarios where value of a parameter is above or below the associated threshold value. In other words, a parameter may not meet established industry standards or specifications. In such case, deviation information for the parameter is collated on the distributed ledger network 106. It will be apparent to a person skilled in the art that values of more than one parameter may deviate from associated threshold value. In other words, deviation may be observed at more than one steps in the end-to-end process. The deviation for a parameter in a vector (either of input vector, action vector, or output vector) is indicative of an issue that may have been introduced by a stakeholder intentionally or inadvertently. In continuation of the example above, the farmer may have used seeds with size falling out of the specified size range. This deviation information will be collated on the distributed ledger network 106.

In an embodiment, a mashup script installed at stakeholder's computing system may be used to collate the deviation information for the one or more parameters. The mashup script may then record the deviation information on one or more of the plurality of distributed ledger nodes 108. The deviation information may be recorded based on predefined business rules and the type of deviation information. The mashup script is responsible to collate other relevant information pertaining to the abnormalities related to a resultant product or service. By way of an example, if there was a drop in temperature during food transport, a mashup script may get executed to retrieve details related to past truck service schedule. Other stakeholders may not find this information useful until and unless there was an abnormal condition. By way of another example, when a batch of food was rated as below quality, a mashup script may get executed to find out the stakeholder or supervisor involved in production of that batch of food. These mashup scripts are automatically executed depending upon the situation and the information thus captured acts as a source to find out the exact step or reason that lead to an issue.

As each of the plurality of stakeholders 102 is communicatively coupled to one of the plurality of distributed ledger nodes 108, accordingly, the deviation information for a parameter associated with a stakeholder may be recorded on a distributed ledger node communicatively coupled to that stakeholder. By way of an example, if the stakeholder 102-1 is a farmer who used a seed size that deviates from a seed size threshold, the deviation information regarding the seed size is stored in the distributed ledger node 108-1.

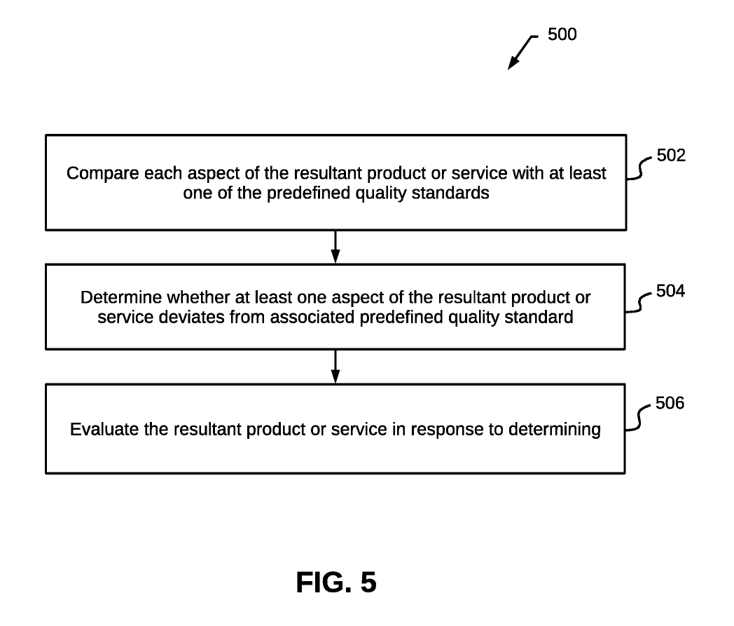

At step 310, the issue tracing device 104 evaluates a resultant product or service obtained after the end-to-end process based on predefined quality standards. The resultant product or service may be evaluated either manually or by an automation technique. Alternately, the resultant product or service may be evaluated by IoT sensors or by using any known technique, such as, image recognition. The process of evaluating the resultant product or service is explained in detail in conjunction with FIG. 5.

Based on the evaluation of the resultant product or service, the issue tracing device 104 traces an issue and a location of that issue in the end-to end process. The issue and the location of the issue may be traced by analyzing the deviation information collated on the distributed ledger network 106. By way of an example, the evaluation of a resultant product may indicate that the product does not meet the predefined quality standards. In response to this, the issue tracing device 104 may automatically execute a back tracing algorithm that may access and analyze the distributed ledger network 106 in order to access deviation information collated on the distributed ledger network 106. Based on this, the back tracing algorithm may identify the issue and the exact location of the issue in the end-to-end process. The deviation information recorded in the distributed ledger nodes 108 may be analyzed backwards starting from the last stakeholder in the end-to-end process. Further, the plurality of input, action, and output vectors may be analyzed to locate the step in the end-to-end process, where the issue may have occurred.

By way of an example, the back tracing algorithm may execute the following steps in order to trace the issue and the location of the issue in the end-to-end process. In the first step, a total number (N) of stakeholders in the end-to-end prices may be determined. In the next step, the output, input, and action vectors may be analyzed for identifying the last stakeholder, i.e., the one with the greatest serial number in the count N. Based on the analysis, values associated with the parameters in different vectors are determined. Thereafter, in the final step, the values are compared against threshold values to identify any issues. Further, various rules may be applied for carrying out the analysis based on the type of resultant product or service, location in the end-to-end process, and the type of vectors. The algorithm may run in a loop, and may continue to run until all the vectors associated with all the stakeholders are analyzed.

Once the issue and the location of the issue is identified, the issue and the location of the issue may be formulated in a template which may be defined by an administrator. Thereafter, information about the issue and the location of the issue may be reported to each of the plurality of stakeholders 102. The information may be reported to the plurality of stakeholders 102 using any known communication protocols.

By way of an example of the method described above, an end-to-end process of manufacturing food product jam is described below. Exemplary threshold values associated various parameters in the input vector, action vector, and output vector are provided in the Table 1 below:

TABLE 1

| | |
|---|---|
| Input | [0.01 mm <= Seed Size <= 0.1 mm; Seed Origin = Kenya |
| Vector | or Java; 1 day <= Seed Age <= 1 month; Fertilizer Type = |
| | Urea; Fertilizer Constituents = Nitrate, Phosphate; Pesticide |
| | Type = Organic; Pesticide Constituents = Bacteria X] |
| Action | [January <= Sowing Time <= March; Nitrate 20% <= |
| Vector | Soil Quality <= Nitrate 35%, 15% <= Soil Humidity <= 30%; |
| | 20-C. <= Soil Temp <= 30-C.; −3 <= Soil ph <= +1] |
| Output | [Light Yellow <= Leaf Color <= Light Green; Soft <= Leaf |
| Vector | Quality <= Crisp; Pink <= Flower Color <= Light Red; |
| | Flower Smell = None; Flower Taste = Pungent; Light Green < |
| | Fruit Color < Deep Green; Fruit Smell = Rosy; Lightly |
| | Sweet <= Fruit Taste < Very Sweet] |

Once values are determined for the parameters in each of the input vector, action vector, and output vector, comparison with the associated thresholds identifies the issues within the end-to-end process. This is depicted in Table 2 given below (the underlined parameters indicate deviation from associated threshold values and hence the issues in the end-to-end process):

TABLE 2

| Intended | Actual |
|---|---|
| Input Vector | Input Vector |
| [0.01 mm <= Seed Size <= 0.1 mm; Seed | [ 0.01 mm <= Seed Size <= 0.1 mm; Seed |
| Origin = Kenya or Java; | Origin = Kenya or Java; |
| 1 day <= Seed Age <= 1 month; Fertilizer | Seed Age <= 1 month 7 days; Fertilizer |
| Type = Urea; Fertilizer Constituents = | Type = Urea; Fertilizer Constituents = |
| Nitrate, Phosphate; Pesticide Type = | Nitrate, Phosphate; Pesticide Type = |
| Organic; Pesticide Constituents = Bacteria | Organic; Pesticide Constituents = Bacteria |
| X] | X] |
| Action Vector | Action Vector |
| [A₁, A₂, . . ., Aₖ] = | [January <= Sowing Time <= March; Nitrate |
| [January <= Sowing Time <= March; | 20% <= Soil Quality <= Nitrate 35%, |
| Nitrate 20% <= Soil Quality <= Nitrate 35%, | 15% <= Soil Humidity <= 30%; 10-C. <= Soil Temp <= |
| 15% <= Soil Humidity <= 30%; 20-C. <= Soil | 18-C.; −3 <= Soil nh <= +1] |
| Temp <= 30-C.; −3 <= Soil nh <= +1] | |
| Output Vector | Output Vector |
| [Light Yellow <= Leaf Color <= Light | [Light Yellow <= Leaf Color <= Light |
| Green; Soft <= Leaf Quality <= Crisp; | Green; Soft <= Leaf Quality <= Crisp; |
| Pink <= Flower Color <= | Pink <= Flower Color <= |
| Light Red; Flower Smell = None; | Light Red; Flower Smell = None; |
| Flower Taste = Pungent; Light | Flower Taste = Pungent; Light |
| Green < Fruit Color < Deep Green; | Yellow < Fruit Color < Yellow; |
| Fruit Smell = Rosy; Lightly | Fruit Smell =Rosy; Lightly Sweet <= Fruit |
| Sweet <= Fruit Taste < Very Sweet] | Taste < Very Sweet] |

From the table 2, it is evident that, on the part of the stakeholder farmer, there have been issues with respect to the parameter of ‘seed age’ in the input vector, the parameter of ‘soil temperature’ in the action vector, and the parameter of ‘fruit color’ in the output vector. As a result, a food product, such as jam manufactured by a food manufacturer using the produce of the famer may be of substandard quality. Although, the food manufacturer has not defaulted in his task, but due to faulty performance of the task by the farmer, the resultant product of this process turns out to be of sub-standard quality, due to which the business of the food manufacturer is affected.

Since such deviation information would be stored on the distributed ledger network 106, the issue tracing device 104 may use the backtracing algorithm to access the deviation information from the distributed ledger network 106 and thereafter identify the issue and the exact location of the issue in the end-to-end process.

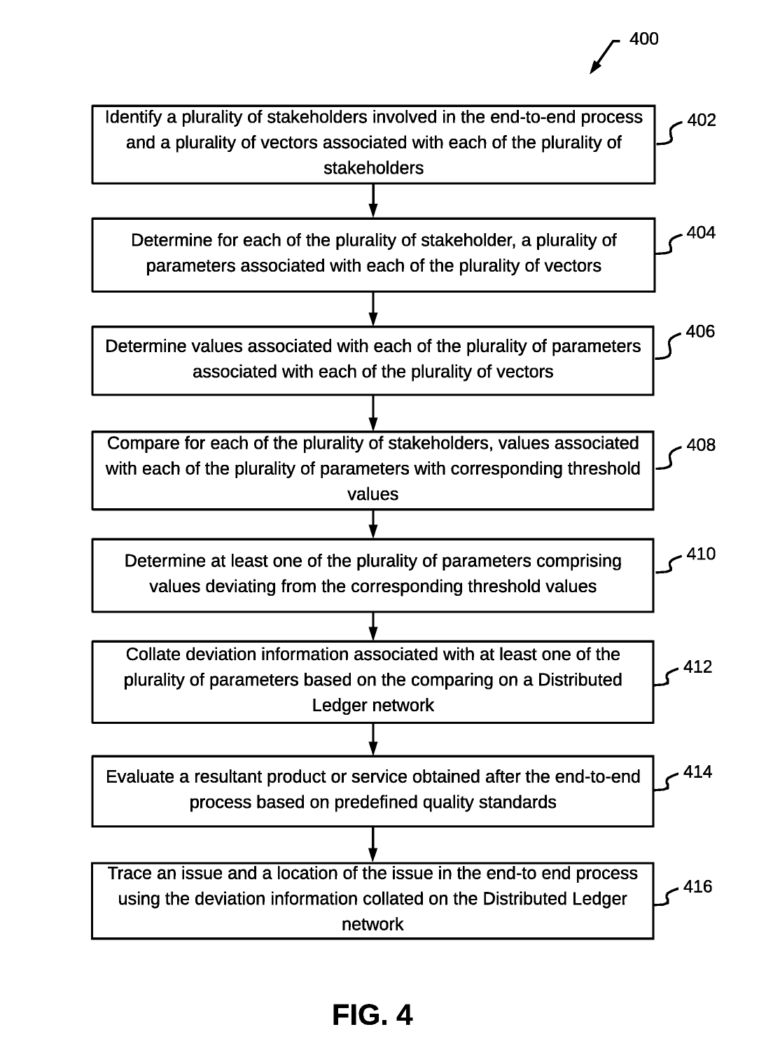

Referring now to FIG. 4, a flowchart of a method 400 for tracing issues in an end-to-end process using the distributed ledger network 106 is illustrated, in accordance with another embodiment. At step 402, the plurality of stakeholders 102 involved in the end-to-end process are identified. Additionally, at step 402, a plurality of vectors associated with each of the plurality of stakeholders 102 are identified. At step 404, a plurality of parameters associated with each of the plurality of vectors for each of the plurality of stakeholders 102 are determined. This has been explained in detail in conjunction with FIG. 3. Thereafter, values for each of the plurality of parameters associated with each of the plurality of vectors are determined at step 406. These values are then compared with corresponding threshold values at step 408. Thereafter, at step 410, one or more of the plurality of parameters that have values deviating from the corresponding threshold values are determined. The one or more parameters may be determined by comparing values associated with the parameters with the threshold values. Steps 412 to 416 are then executed. These steps are analogous to steps 308 to 312 and are thus already explained in detail in conjunction with FIG. 3.

Referring to FIG. 5, a flowchart of a method 500 for evaluating a resultant product or service obtained after the end-to-end process based on predefined quality standards is illustrated, in accordance with an embodiment. At step 502, each aspect of the resultant product or service is compared with one or more predefined quality standards. The predefined quality standards, for example, may be industry defined specifications for a given product or service. By way of an example, various standards set by International Organization for Standardization (ISO) may be used for such evaluation. The resultant product or service may be evaluated either manually or by an automation technique. By way of an example, IoT sensors or image recognition techniques may be used for such evaluation.

Based on the comparison, at step 504, it is determined whether one or more aspects of the resultant product or service deviates from the associated predefined quality standard. The aspects for a given product or service may be pre-identified. By way of an example, for Jam made by using a fruit, various aspects may include: taste, texture, odor, smell, consistency, color, or packing. These aspects are compared with associated predefined quality standards to determine deviation, if any. At step 506, in response to determining whether one or more aspects of the resultant product or service deviates from associated predefined quality standard, the resultant product or service is evaluated. In other words, it is determined whether the product or service has some defects or if it meets the expected quality standards. Thus, if any aspect of the product or service does not meet the required quality standard, a back tracing algorithm is executed to trace issues in the end-to-end process.

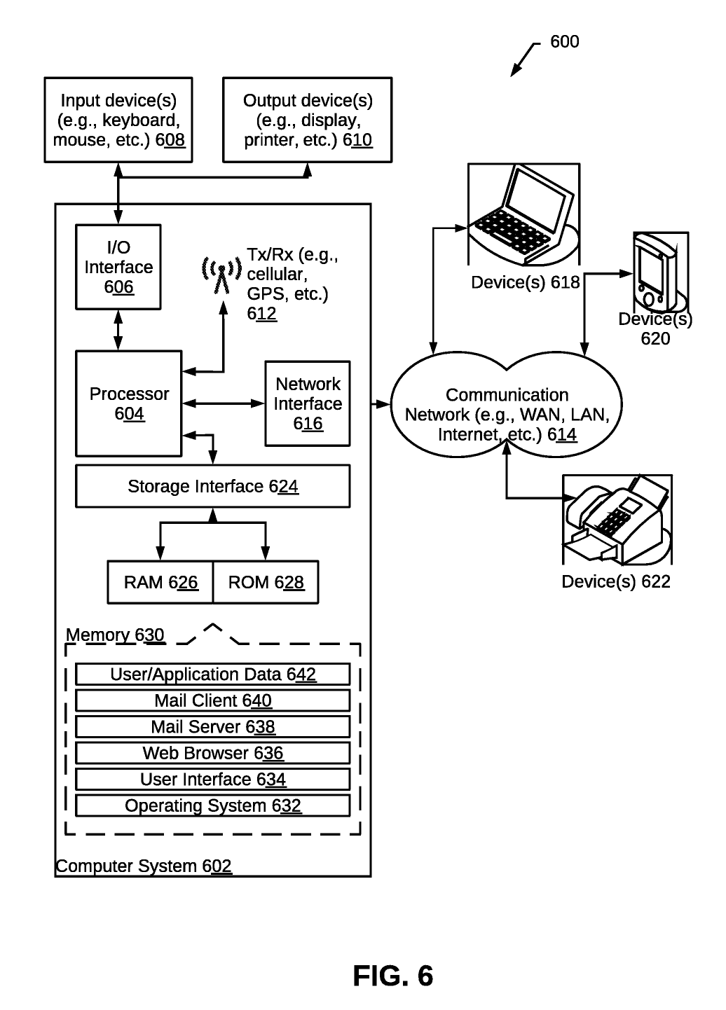

FIG. 6 is a block diagram of an exemplary computer system for implementing various embodiments. Computer system 602 may include a central processing unit (“CPU” or “processor”) 604. Processor 604 may include at least one data processor for executing program components for executing user- or system-generated requests. A user may include a person, a person using a device such as such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 610 may be a printer, fax machine, video display (e.g., cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (e.g., TEXAS® INSTRUMENTS WILINK WL1283® transceiver, BROADCOM® BCM4550IUB8® transceiver, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc. Communication network 614 may include, without limitation, a direct interconnection, local area network (LAN), wide area network (WAN), wireless network (e.g., using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (e.g., APPLE® IPHONE® smartphone, BLACKBERRY® smartphone, ANDROID® based phones, etc.), tablet computers, eBook readers (AMAZON® KINDLE® ereader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (e.g., RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (e.g., any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (e.g., Berkeley Software Distribution (BSD), FreeBSD, NetBSD, OpenBSD, etc.), LINUX distributions (e.g., RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (e.g., AERO® platform, METRO® platform, etc.), UNIX X-WINDOWS, web interface libraries (e.g., ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APis), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT.NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail client, MICROSOFT ENTOURAGE® mail client, MICROSOFT OUTLOOK® mail client, MOZILLA THUNDERBIRD® mail client, etc.

In some embodiments, computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (e.g., XML), table, or as object-oriented databases (e.g., using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide method and device for tracing issues in an end-to-end process using distributed ledger. The method enables storing only relevant information in the distributed ledger regarding the end-to-end process, and hence is scalable. This allows for going backwards in the end-to-end process to identify the issues and the location of the issues that may have occurred in the end-to-end process, thereby further enabling identification of stakeholders responsible for giving rise to the issue. Further, information on the distributed ledger network may be collated from multiple heterogeneous sources, such as a plurality of stakeholders, and may be stored as mash-up information. Furthermore, any deviations of the resultant product or service of the end-to-end process with respect to predefined quality standards may be automatically detected using the backtracing algorithm. Moreover, the method provides a generic solution, and may be customized and applied for various different domains with some modifications

The specification has described method and device for tracing issues in an end-to-end process using distributed ledger. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for tracing issues in an end-to-end process, the method comprising:
identifying, by an issue tracing device, a plurality of stakeholders involved in the end-to-end process and a plurality of vectors associated with each of the plurality of stakeholders;
determining, by the issue tracing device, for each of the plurality of stakeholders, a plurality of parameters associated with each of the plurality of vectors;
comparing, by the issue tracing device, for each of the plurality of stakeholders, values associated with each of the plurality of parameters with corresponding threshold values;
collating, by the issue tracing device, deviation information associated with at least one of the plurality of parameters based on the comparing, on a distributed ledger network;
evaluating, by the issue tracing device, a resultant product or service obtained after the end-to-end process based on predefined quality standards; and
tracing, by the issue tracing device, an issue and a location of the issue in the end-to end process using the deviation information collated on the distributed ledger network, wherein tracing of the issue and the location is initiated based on the evaluating.

2. The method of claim 1, wherein the plurality of stakeholders and the plurality of vectors are identified using a machine learning technique.

3. The method of claim 1, wherein the plurality of vectors associated with a stakeholder from the plurality of stakeholders comprise at least one input vector, at least one action vector, and at least one output vector.

4. The method of claim 3, wherein one of the at least one action vector acting on one of the at least one input vector results in one of the at least one output vector.

5. The method of claim 1, further comprising determining values associated with each of the plurality of parameters associated with each of the plurality of vectors.

6. The method of claim 5, wherein the values associated with each of the plurality of parameters associated with each of the plurality of vectors are determined using Internet of Things (IoT) sensors.

7. The method of claim 1, further comprising determining at least one of the plurality of parameters comprising values deviating from the corresponding threshold values.

8. The method of claim 1, wherein the distributed ledger network comprises a plurality of distributed ledger nodes, wherein each distributed ledger node is associated with one of the plurality of stakeholders, and wherein value of a parameter deviating from a corresponding threshold value is stored in an associated distributed ledger node.

9. The method of claim 1, wherein evaluating comprises:
comparing each aspect of the resultant product or service with at least one of the predefined quality standards;
determining whether at least one aspect of the resultant product or service deviates from associated predefined quality standard; and
evaluating the resultant product or service in response to determining.

10. An issue tracing device for tracing issues in an end-to-end process, the issue tracing device comprising:
a processor; and
a memory communicatively coupled to the processor, wherein the memory stores processor instructions, which, on execution, causes the processor to:
identify a plurality of stakeholders involved in the end-to-end process and a plurality of vectors associated with each of the plurality of stakeholders;
determine for each of the plurality of stakeholder, a plurality of parameters associated with each of the plurality of vectors;
determine values associated with each of the plurality of parameters associated with each of the plurality of vectors;
compare for each of the plurality of stakeholders, values associated with each of the plurality of parameters with corresponding threshold values;
collate deviation information associated with at least one of the plurality of parameters based on the comparing, on a distributed ledger network;
evaluate a resultant product or service obtained after the end-to-end process based on predefined quality standards; and
trace an issue and a location of the issue in the end-to end process using the deviation information collated on the Distributed ledger network, wherein tracing of the issue and the location is initiated based on the evaluating.

11. The issue tracing device of claim 10, wherein the plurality of stakeholders and the plurality of vectors are identified using a machine learning technique.

12. The issue tracing device of claim 10, wherein the plurality of vectors associated with a stakeholder from the plurality of stakeholders comprise at least one input vector, at least one action vector, and at least one output vector.

13. The issue tracing device of claim 12, wherein one of the at least one action vector acting on one of the at least one input vector results in one of the at least one output vector.

14. The issue tracing device of claim 10, wherein processor instructions further cause the processor to determine values associated with each of the plurality of parameters associated with each of the plurality of vectors.

15. The issue tracing device of claim 14, wherein the values associated with each of the plurality of parameters associated with each of the plurality of vectors are determined using Internet of Things (IoT) sensors.

16. The issue tracing device of claim 10, wherein the processor instructions further cause the processor to determine at least one of the plurality of parameters comprising values deviating from the corresponding threshold values.

17. The issue tracing device of claim 10, wherein the distributed ledger network comprises a plurality of distributed ledger nodes, wherein each distributed ledger node is associated with one of the plurality of stakeholders, and wherein value of a parameter deviating from a corresponding threshold value is stored in an associated distributed ledger node.

18. The issue tracing device of claim 10, wherein the processor instructions further cause the processor to:
compare each aspect of the resultant product or service with at least one of the predefined quality standards;
determine whether at least one aspect of the resultant product or service deviates from associated predefined quality standard; and
evaluate the resultant product or service in response to determining.

19. A non-transitory computer-readable storage medium having stored thereon, a set of computer-executable instructions causing a computer comprising one or more processors to perform steps comprising:
identifying a plurality of stakeholders involved in the end-to-end process and a plurality of vectors associated with each of the plurality of stakeholders;
determining for each of the plurality of stakeholder, a plurality of parameters associated with each of the plurality of vectors;
determining values associated with each of the plurality of parameters associated with each of the plurality of vectors;
comparing for each of the plurality of stakeholders, values associated with each of the plurality of parameters with corresponding threshold values;
collating deviation information associated with at least one of the plurality of parameters based on the comparing, on a distributed ledger network;
evaluating a resultant product or service obtained after the end-to-end process based on predefined quality standards; and
tracing an issue and a location of the issue in the end-to end process using the deviation information collated on the distributed ledger network, wherein tracing of the issue and the location is initiated based on the evaluating.
